(19) United States
(12) Patent Application Publication
(10) Pub. No.: US 2006/0010173 A1
(43) Pub. Date: Jan. 12, 2006

(54) Methods and systems for client-side, on-disk caching

(76) Inventors: Roger Warren Kilday, Livermore, CA (US); Edward Charles Bueche, San Ramon, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/170,799

(22) Filed: Jun. 30, 2005

Related U.S. Application Data
(60) Provisional application No. 60/584,766, filed on Jun. 30, 2004.

(51) Int. Cl. G06F 12/00

(52) U.S. Cl. 707/200

(57) ABSTRACT

A system and method for persistently caching data elements in the internal storage of a client connected to an enterprise network allows for the rapid access of data elements by the client. The persistent caching of data elements significantly reduces the number of times the client must request data elements from a remote storage area. The persistently cached data elements are further checked for coherency with the server at specified intervals to make certain that the cached copies are always coherent with the server when called by a client application.

This application claims the benefit of priority of U.S. Provisional Application No. 60/584,766, filed Jun. 30, 2004, which is incorporated herein by reference.

### TECHNICAL FIELD

The invention is related to the field of enterprise computer network systems, and methods of caching data elements that are transmitted from server to client on the network.

### BACKGROUND

In an enterprise computer network, there may be several client computers (“clients”) connected to a server computer (“server”). As application programs (“applications”) executing in the clients request data elements, such as queries, content, and objects, from the server, the client must initiate many calls to the server in order to obtain the data elements that are needed by an application. The server must then handle all of the calls, and process and complete each one. The amount of data elements transferred from the server to the clients may create much traffic. The data elements that are transferred are then locally copied (“cached”) on the client computer for easy access. However, as the client's cache is filled up with other data, the data elements that were requested from the server are emptied from the cache and, if needed again, must be re-retrieved from the server. Throughout the course of a connection with the server, as the cache is emptied and re-filled, data elements necessary for the operation of a client application may be called and retrieved from the server many times, creating a significant slowdown in the client application.

FIG. 1A is a diagram showing a general system for on-disk caching, and FIG. 1B is a flowchart illustrating a method of on-disk caching of data, described with reference to the system shown in FIG. 1A. The caching of data elements on a system typically comprises storing the data elements most recently used in a storage area separate from the main internal storage. As is shown in FIG. 1A, an on-disk cache 104 is typically a section of main memory on a controller bridging internal storage 106 with a central processing unit (CPU) 102. Cache 104 may be, for example, static random access memory (SRAM) or dynamic random access memory (DRAM), and internal storage 106 may be, for example, a hard disk. Data can be accessed much more quickly from either SRAM or DRAM than from a hard disk, making it advantageous to store frequently-used, and most-recently-used data stored in a SRAM or DRAM.

Referring still to FIG. 1A, in one exemplary method of on-disk caching, an application 100 executing in a client CPU 102 will initiate a request for data elements from internal storage 106. The requested data elements may be objects, content files, application configuration data, or queries needed for the proper operation of application 100. When internal storage 106 is accessed, a block of data elements is copied into cache 104. The block of data elements that is copied may be a larger block of data elements than immediately required. On subsequent accesses of internal storage 106, cache 104 is checked first to see if the data elements have already been retrieved.

This exemplary method of on-disk caching is also shown in the flowchart that is FIG. 1B. When application 100 requests data elements from storage (step 110), cache 104 is checked to see if it contains the requested data elements (step 112). If the requested data elements are found in cache 104, they will be immediately provided to application 100 from cache 104 (step 116), without needing to access internal storage 106. On the other hand, if the data elements are not found in cache 104, the data elements are retrieved from internal storage 106, and copies are stored in cache 104 (step 114) and then supplied to application 100 (step 116).

On an enterprise network, client applications often request data elements from remote storage locations located on another computer, such as tables in a remote database. Such requests are first handled by the network server, which retrieves the data elements from the database and provides them to the client. An enterprise computer network, with a large number of clients may need to simultaneously handle a large number of such requests which can impact the performance of clients on the network, if not efficiently handled.

FIG. 2 is a diagram showing another system for retrieving data elements on a network from a database according to the prior art. On such a network, a client application 200 executing on client CPU 202 may request data elements stored on a database 210 from a server 208. Such requests may occur many times throughout the course of a connection session with server 208. Typically, when data elements are requested from server 208, copies of the requested data elements are retrieved from server 208, and are stored in a cache 204 of an internal storage 206 of the client for faster access. It will be understood that data elements stored in cache 204, are actually copies of data elements stored on database 210. However, as more and more data elements are stored in cache 204, cache 204 may become full, and the least recently used (LRU) data elements may be deleted to accommodate the most recently used (MRU) data elements. When client application 200 again requests the previously retrieved data elements that have been deleted from cache 204, such data elements may have to be retrieved once again from server 208. In most computing environments, the more data elements that must be retrieved from server 208, the slower client application 200 will appear to a user to operate. Additionally, with a larger number of requests for data elements, the greater the likelihood that the data elements that have been previously retrieved from server 208 and stored in cache 204 have changed over time, such that the original data element stored on server 208 no longer matches the previously retrieved copy of the data element stored in cache 204. Lack of coherency between the copies in cache 204 and the data elements stored on server 208 can cause many problems with both operation of the system and unreliability of the data.

### SUMMARY

Consistent with the invention, there is provided a method for caching data elements on a client connected to a server through a network, wherein the data elements originate on the server, the method comprising selecting at least one data element from a plurality of data elements stored on the server; retrieving the selected at least one data element from the server; storing the selected at least one data element on a storage device, wherein the storage device is located on the client; defining a time period for which the stored at least one data element is considered coherent; and persisting the stored at least one data element in the storage device for at least the time period.

Also consistent with the present invention there is provided a system for on-disk client-side caching comprising a client connected to a server through a network; a database operatively connected to the server; a central processing unit (CPU) in the client which selects at least one data element stored in the database to be stored on a client storage device; retrieves the selected at least one data element and stores a copy of the selected at least one data element on the client storage device; defines a time period for which the copy is considered coherent; and persists the copy on the client storage device for at least the defined time period.

Further consistent with the present invention, there is provided a method of on-disk, client-side caching of data elements, wherein the client is connected to a server on a network, the method comprising selecting at least one data element out of a plurality of data elements stored on a database operatively connected to the server to be cached; defining a check period for the selected at least one data element; retrieving the selected at least one data element from the database; persistently storing a copy of the selected at least one data element in a client's on-disk cache, wherein the copy is considered to be coherent with the database for at least the check period; and determining whether the copy is coherent with the database when the check period expires, wherein if the copy is determined to not be coherent, deleting the copy from the on-disk cache; re-retrieving the selected at least one data element from the database; and persistently storing a coherent copy of the selected at least one data element in the on-disk cache.

Additionally consistent with the present invention, there is provided a method of on-disk, client-side caching of data elements, wherein the client is connected to a server on a network, the method comprising selecting data elements to be cached; defining a group of data elements comprising the selected data elements; defining a check period for the group of data elements; retrieving the group of data elements from the database; persistently storing copies of the data elements in the group in a client's on-disk cache wherein the copies are considered to be coherent with a database operatively connected to the server for at least the check period; and determining whether the copies are coherent with the database when the check period expires, wherein if the copies are determined to not be coherent, deleting the copies from the on-disk cache; re-retrieving the group of data elements from the database; and persistently storing coherent copies of the data elements in the group in the on-disk cache.

The accompanying drawings, which are incorporated in and constitute a part of this specification, illustrate exemplary embodiments of the invention and together with the description, serve to explain the principles of the invention.

### BRIEF DESCRIPTION OF THE DRAWINGS

FIG. 1A is a diagram showing a system for on-disk caching according to the prior art.

FIG. 1B is a flowchart illustrating a method of on-disk caching of data according to the prior art.

FIG. 2 is a diagram showing a system for retrieving objects from a database according to the prior art.

FIG. 3 is a diagram showing a system for retrieving objects and caching the objects on a client storage device consistent with the present invention.

FIG. 4 is a flowchart illustrating a method for on-disk client-side object caching consistent with the present invention.

FIG. 5 is a flowchart illustrating a method of performing a coherency check consistent with the present invention.

FIG. 6 shows a flowchart illustrating a method for grouping selected data elements for persistent caching according to another embodiment consistent with the present invention.

FIG. 7 shows a flowchart illustrating a method for checking the coherency of a requested cached data element that is part of a group of data elements consistent with the present invention.

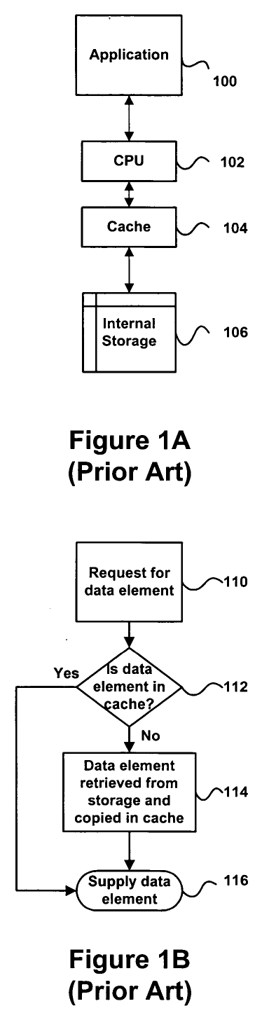

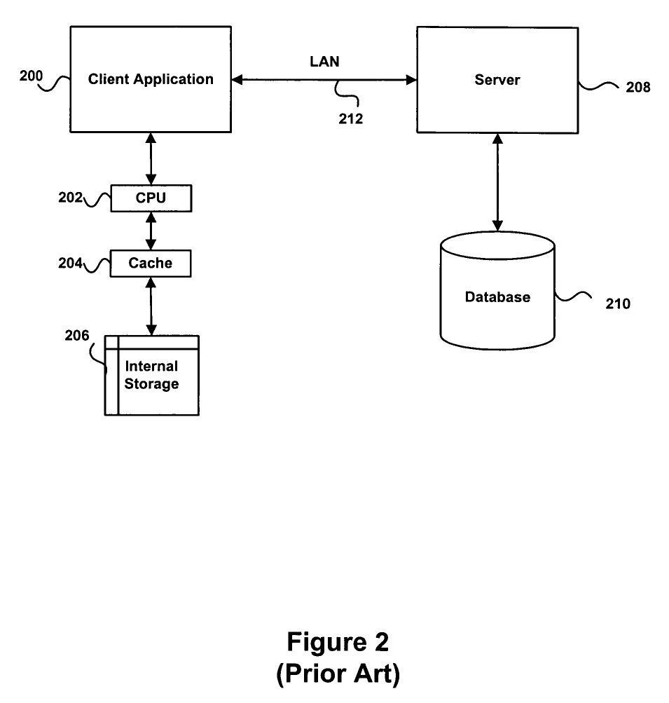

### DETAILED DESCRIPTION

Reference will now be made in detail to the exemplary embodiments that are illustrated in the accompanying drawings. Wherever possible, the same reference numbers will be used throughout the drawings to refer to the same or like parts.

An embodiment consistent with the present invention enables and allows the persistent caching of selected data elements in the on-disk cache of a client, thus allowing rapid access to the selected data elements, and further reducing or eliminating the need for continuous retrieval of data elements from remote storage. Copies of the selected data elements may be persisted in the on-disk cache as long as they are coherent with the original data element stored in remote storage. An embodiment consistent with the present invention further provides a method for maintaining cache coherency, such that only cached copies of data elements that are valid and consistent with the original data elements are provided to a client application requesting the cached copies. An embodiment consistent with the present invention may further provide a means for the immediate retrieval and caching of all data elements flagged for persistent caching upon the connection of a client to the server.

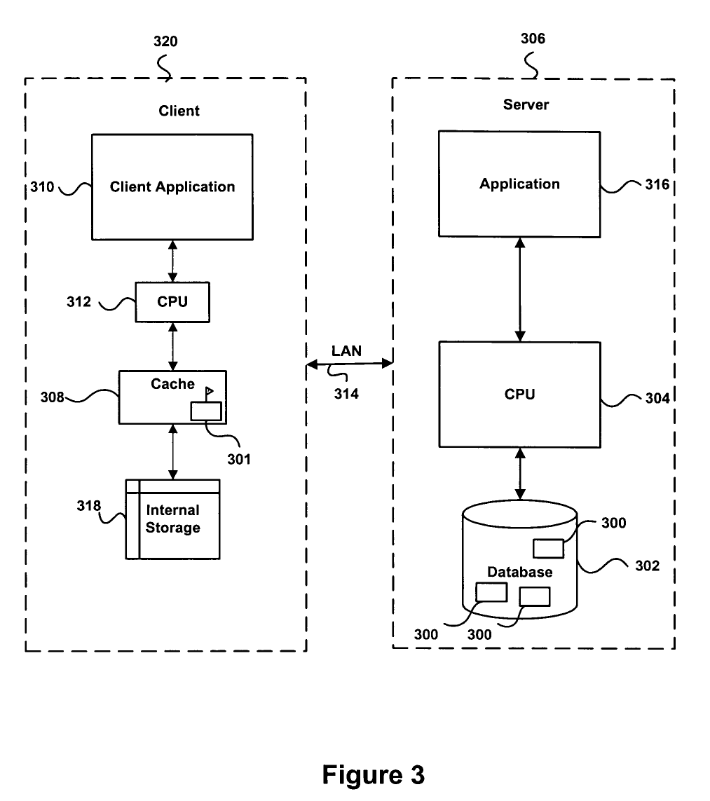

FIG. 3 is a diagram showing a system consistent with the principles of the present invention for retrieving and copying data elements 300 from a database 302 via a CPU 304 executing instructions on a server 306 and caching copies of data elements 300 in an on-disk cache 308 of a client. It will be understood that data elements stored in cache 308 (i.e., “cached data elements”), are actually copies of data elements 300 stored in database 302. A client 320 may be part of an enterprise computer network connected to server 306 via LAN 314, or other suitable connection means, and client 320 may comprise a client application 310 executing on a CPU 312. Database 302 may be, for example, a relational database management system (RDMS) that contains a plurality of data elements 300, and may be included as part of server 306 or located remotely from server 306 and connected by a network.

Data elements 300 that may be frequently retrieved from database 302 can be marked, or “flagged,” for persistent caching in cache 308. When a data element 300 is flagged for persistent caching, a flagged data element 301 may remain, or “persist,” in cache 308 only as long as the cached copy is valid and consistent with the corresponding data element 300 in database 302. In other words, flagged data element 301 must be exactly the same as corresponding data element 300 stored in database 302. Flagged data elements 301 that are valid and consistent are considered to be “coherent.” It is noted again that data elements that are stored in cache 308, such as flagged data element 301, are copies of the original data element 300 stored in database 302.

To enable the persistent caching of data elements, a user may associate properties with data elements 300 that can be used to determine the coherency of the data elements. Properties may be associated by, for example, a user (such as a superuser or administrator) using an application 316 executing on CPU 304. Some examples of properties that may be associated with the data elements include a time period for which the server or the client will consider the data element to be coherent, a data element type, and a timestamp indicating when the data element was last checked or modified.

Referring again to FIG. 3, when client application 310 executing on CPU 312 requests one or more data elements 300 from database 302, a request, executed by CPU 312, is sent from client application 310 to server 306. CPU 304 of server 306 executes instructions for retrieving copies of the requested data elements 300 from database 300 and provides the copies of data elements 300 to client application 310. CPU 312 stores the copies in cache 308 of internal storage 318 of the client. If a data element 300 has been flagged for persistent caching, the corresponding copy of the data element 300 (shown as flagged data element 301) is persisted in cache 308, such that it is not necessary to re-retrieve that data element from database 302 on subsequent connections. As can be readily understood, elimination of the need for client application 310 to obtain a data element from database 302 will enable client application 310 to operate faster.

Ideally, cache 308 should be large enough so that it can persistently store copies of all of the data elements flagged for persistent caching. In certain embodiments consistent with the present invention, the configuration of cache 308 may be changed such that flagged data elements 301 are given preference over copies of data elements not flagged for persistent caching. For example, in certain embodiments, data elements not flagged for persistent caching will be deleted from cache 308 first.

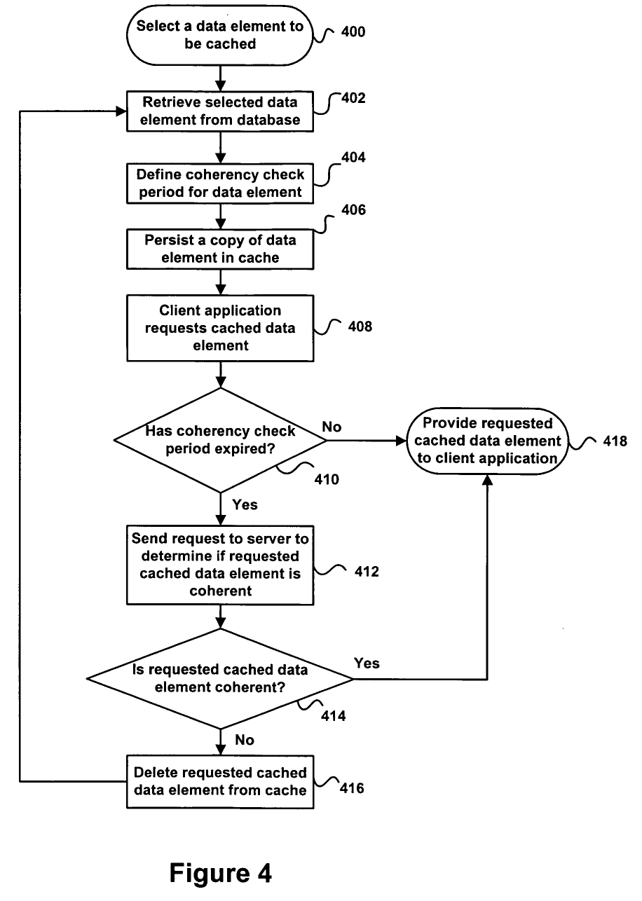

FIG. 4 is a flowchart illustrating an exemplary method for on-disk client-side caching consistent with the present invention. As shown in FIG. 4, a user selects at least one data element that is likely to be repeatedly called from the server and indicates that this at least one data element is to be cached in a client's on-disk cache (step 400). A copy of the selected at least one data element is retrieved from the database and stored in the client's on-disk cache (step 402). The at least one selected data element may be retrieved, for example, by using a retrieval application programming interface (API), wherein arguments of the retrieval API define the data element as being flagged for persistent caching.

In certain embodiments, the API also associates with the at least one data element a time period called the “coherency check period” (step 404). The coherency check period is a time period during which the stored copy is assumed to be coherent or “valid.” That is, if a client application requests a data element within its coherency check period, the client application will not check to see if the copy stored in cache is coherent with the corresponding original data element stored in the database but will assume coherency. Time periods associated with the data element may be set by a user, and ideally should be chosen such that there is a low probability that the data element will be changed during the time period. Coherency check periods may be defined by one or more numerical values or arguments.

In step 406, the at least one selected data element with an associated coherency check period is flagged for persistence in on-disk cache and a copy of the at least one selected data element is persistently cached. Client applications requesting a persistently cached data element will access the copy of the requested data element from the cache (step 408). On each access of a persistently cached data element, the client CPU will determine if the coherency check period for that requested cached data element has expired (step 410). If the coherency check period has not expired, then the copy of the requested cached data element stored in the cache is provided to the application that has requested access (step 418).

If the coherency check period has expired, a request will be sent to the server to determine if the requested cached data element is still coherent (step 412). After this request, the CPU on the server will execute instructions for comparing the requested cached data element with the original data element to determine if the requested cached data element is coherent (step 414). If associated properties of the requested cached data element match associated properties of the original data element, the requested cached data element will be determined to be coherent and will be provided to the client application (step 418).

If the requested cached data element is determined to be not coherent with the original data element, then the requested cached data element is deleted from the cache (step 416). A coherent copy of the original requested data element is retrieved from the server (step 402) and flagged for persistent caching in the on-disk cache where it is persisted until determined to be no longer coherent.

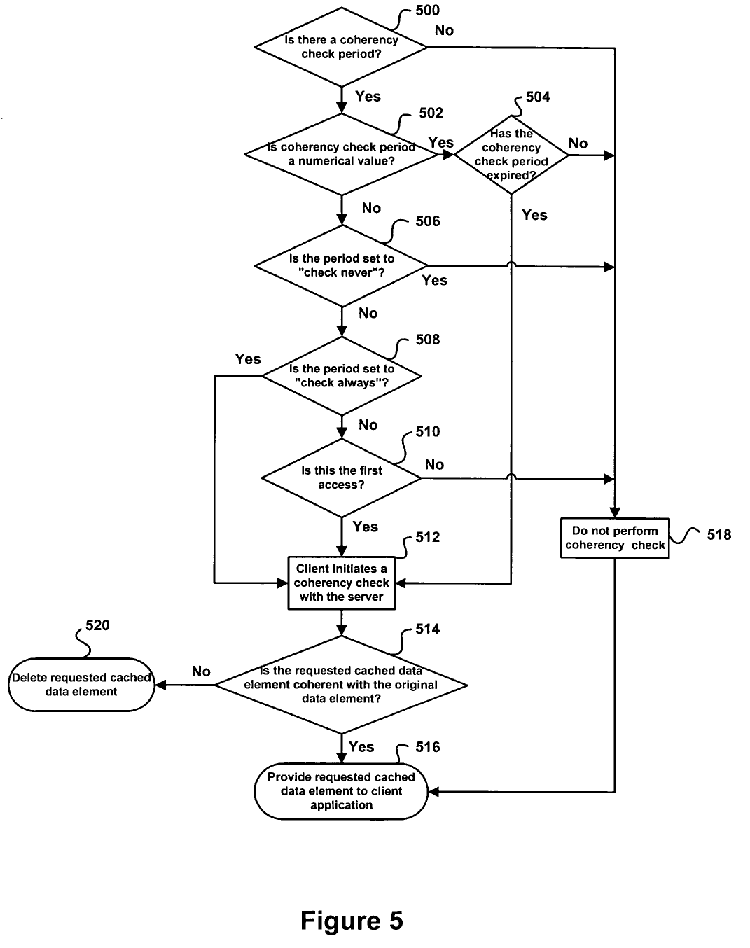

FIG. 5 shows a flowchart illustrating a method of coherency checking consistent with the present invention. As discussed above, when a client application requests a cached data element that has been flagged for persistent caching, the cached data element may have an associated coherency check period (step 500). If a requested cached data element does not have an associated coherency check period, a coherency check is not performed (step 518). The requested cached data element is subsequently provided to the client application (step 516).

If, however, the requested cached data element has an associated coherency check period, the coherency check period may be a numerical value or an argument (step 502). If the coherency check period is a numerical value, the client CPU will determine if the coherency check period has expired (step 504). If the coherency check period has not expired, the requested cached data element is within its coherency check period, and is assumed to be coherent with the original data element. Thus, a coherency check is not performed (step 518), and the requested cached data element is provided to the client application (step 516).

If, however, a coherency check period associated with the requested cached data element is not a number, the coherency check period may be an argument defining a set of rules. For example, the coherency check period may be set to “check always.” As the name suggests, on each request of the cached data element, the requested cached data element is checked for coherency with the original data element. Alternatively, for example, the coherency check period may be set to “check never,” wherein the requested cached data element is never checked for coherence with the original data element. The coherency check period may alternatively be set to “check on first access,” wherein a request of the cached data element only triggers a coherency check on the first access of the requested cached data element.

Referring again to FIG. 5, if the coherency check period is not a number, a check is performed to determine if the coherency check period is set to “check never” (step 506). If the coherency check period is set to “check never,” the requested cached data element is not checked for coherency (step 518), and is subsequently provided to client application (step 516). If, however, the coherency check period is determined to not be set to “check never,” a check is performed to determine if the coherency check period is set to “check always” (step 508). If the coherency check period is indeed set to check always, on each access of the requested cached data element, the client initiates a coherency check with the server (step 512). If, however, the coherency check period is determined to not be set to “check always,” the coherency check period, already determined to not be a numerical value at step 502, the coherency check period is assumed to be set to “check on first access.” A check is performed to determine if this is the first access of the requested cached data element (step 510). If this access of the requested cached data element is determined to be the first access, the client will initiate a coherency check with the server (step 512). If, however, it is determined that this access of the requested cached data element is not the first access, a coherency check is not performed (step 518), and the requested cached data element is provided to the client application (step 516).

Whenever it is determined that a coherency check must be made, the client will initiate a coherency check with the server (step 512). The CPU on the server will execute instructions for comparing associated properties of the requested cached data element with associated properties of the original data element to determine if the requested cached data element is coherent with the original requested data element (step 514). If the requested cached data element is determined to be coherent with the original data element, it will be provided to the requesting client application (step 516). If, however, the requested cached data element is determined to be not coherent with the original data element, the requested data element is deleted from the cache (step 520). As described above, a coherent copy of the requested data element will be retrieved from the database and persistently cached until it is no longer determined to be coherent.

Alternatively, if the requested cached data element is a query, when a coherency check is performed, a method consistent with the present invention may use a generated “hash” value to determine if the query is coherent. As is known to those skilled in the art, a hash value is a unique number generated from a set of input data by a hash algorithm or function. The query will be run, and the results of the query, and the query itself, are fed into a stream hash function. The stream hash function computes a hash value of each query run. The generated hash value is compared against the previous query execution to see if the last results are still coherent

The particular definition of the coherency check period is not limited to the above embodiments. Since the methods for retrieving objects and performing queries remain the same regardless of the coherency check period employed, the coherency check period may be an argument or numerical value, as described above. Alternatively, for example, the coherency check period may be defined by an algorithm, transparent to the user, that defines the period as an argument or numerical value, depending on whether the data element is an object or query.

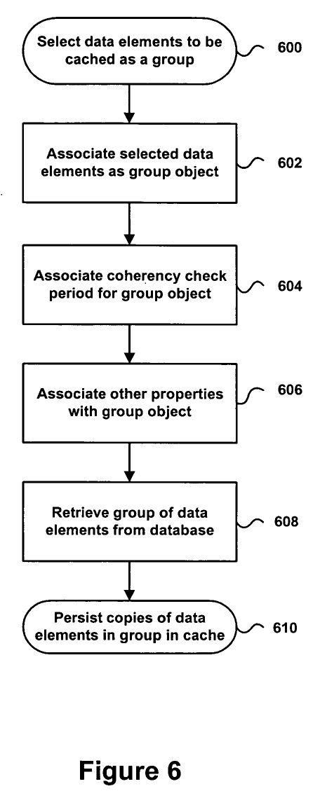

FIG. 6 shows a flowchart illustrating a method for grouping selected data elements for persistent caching according to another embodiment consistent with the present invention. As shown in FIG. 6, a user selects a plurality of data elements that are likely to be repeatedly called from the server and indicates that the plurality of data elements are to be cached in a client's on-disk cache as a group (step 600). The selected data elements are defined as a group using a group object. The group object further associates other properties with the selected data elements, including the coherency check period. For example, the associated properties of the group object may further define the name and type of all of the data elements in the group, the time and date of the last coherency check, the time and date of the last instance where a coherency check had determined any of the data elements in the group were not coherent with the original data elements on the server, and a hash value associated with the last coherency check.

Referring again to FIG. 6, the selected data elements are associated as a group object (step 602). The coherency check period is defined and associated with the group object (step 604). As before, coherency check periods may be defined by one or more numerical values or arguments. Any other properties that are listed above may then be associated with the group object (step 606). The selected group of data elements are retrieved from the database (step 608), and copies of the selected data elements comprising the group of data elements are persisted in cache until the copies are no longer determined to be coherent (step 610).

The group object allows for the coherency of all of the cached data elements in the group to be determined based on a single call to the server initiating a coherency check for one data element in the group. If any of the cached copies of the selected data elements comprising the group of data elements is determined to not be coherent with the original data elements in the database, the entire group of cached data elements is subsequently deleted from the cache. The data elements comprising the group of data elements are retrieved from the database and copies are persistently cached until they are no longer determined to be coherent. The ability to group data elements together in the cache allows for a method of coherency checking that is more effective than checking each cached data element in the group individually. Moreover, the group of data elements may be considered not coherent as a whole, making it less likely that a client application accessing a data element in the group, or many data elements in the group, will encounter errors because it sees one coherent data element and another data element that is not coherent. The ability to check the coherency of a group of data elements as a whole is not limited to the particular embodiments disclosed herein, as the method could be used in other applications that utilize caching of static objects, for example, web browsers.

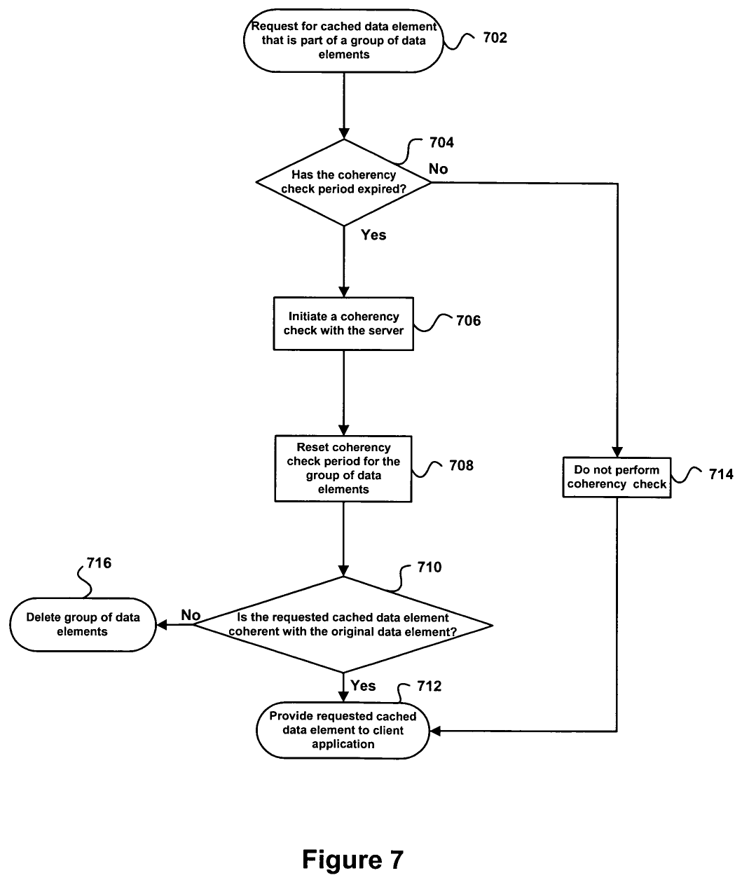

FIG. 7 shows a flowchart illustrating a method for checking the coherency of a requested cached data element that is part of a group of data elements consistent with the present invention. A client application requests a cached data element that is part of a group of data elements (step 702). The client CPU performs a check to determine if the coherency check period of the requested data element has expired (step 704). The method shown in FIG. 7 assumes that the coherency check period is a numerical value, but the same process may be applied for coherency check periods that are not numerical values, as shown above in FIG. 5.

Referring again to FIG. 7, if the coherency check period has not expired, the requested cached data element is within its coherency check period, and is assumed to be coherent with the original data element. Thus, a coherency check is not performed (step 714), and the requested cached data element is provided to the client application (step 712). If the coherency check period has expired, the client will initiate a coherency check with the server (step 706). The CPU on the server will execute instructions for comparing associated properties of the requested cached data element with associated properties of the original data element to determine if the requested cached data element is coherent with the original requested data element (step 710). By initiating a coherency check on one data element of the group of data elements, the coherency check period for the group of data elements is reset (step 708). For example, if a first data element from the group of data elements is checked for coherency (step 710), the coherency check period for all data elements in the group of data elements is reset (step 708). Accordingly, should a second data element that is part of the same group of data elements as the first data element be requested immediately after the first data element (step 702), since the coherency check period has been reset, the coherency check period of the second data element will not be determined to have expired. Thus a coherency check would not be performed on the second data element (step 714).

Referring again to FIG. 7, if the requested cached data element is determined to be coherent with the original data element, it will be provided to the requesting client application (step 712). If, however, the requested cached data element is determined to be not coherent with the original data element, all of the data elements in the group of data elements are deleted from the cache (step 716). Coherent copies of the data elements in the group of data elements will be retrieved from the database and persistently cached until one data element is no longer determined to be coherent.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for caching data elements on a client coupled to a server, wherein the data elements originate on a database operatively connected to a server, the method comprising:
selecting at least one data element from a plurality of data elements stored on the database;
retrieving the selected at least one data element from the database;
storing a copy of the selected at least one data element on a storage device associated with the client;
defining a time period for which the copy is considered coherent; and
persisting the copy in the storage device for at least the time period.

2. The method of claim 1, further including:
determining if the time period has expired, and
if the time period has expired, determining if the copy is coherent.

3. The method of claim 2, wherein if the copy is determined to not be coherent:
deleting the copy from the storage device; and
re-retrieving the selected at least one data element from the database; and
storing a coherent copy of the selected at least one data element on the storage device.

4. The method of claim 1, wherein selecting at least one data element further comprises:
selecting a plurality of data elements from the plurality of data elements stored on the database; and
forming a group of selected data elements, wherein the time period for copies of the selected data elements in the group stored on the storage device is the same.

5. The method of claim 4, further including:
determining if the time period has expired, and
if the time period has expired, determining if at least one of the copies are coherent.

6. The method of claim 5, wherein if the copies are not coherent:
deleting the copies from the storage device; and
re-retrieving the group of selected data elements; and
storing coherent copies on the storage device.

7. The method of claim 2, wherein:
the copy is considered to be coherent if an associated property of the stored copy matches an associated property of the selected at least one data element stored on the database.

8. The method of claim 5, wherein:
the copies are considered to be coherent if an associated property of at least one of the copies of the selected data elements stored on the storage device matches an associated property of at least one of the selected data elements stored on the database.

9. A system for on-disk client-side caching comprising:
a client connected to a server through a network;
a database operatively connected to the server;
a central processing unit (CPU) in the client which:
selects at least one data element stored in the database to be stored on a client storage device;
retrieves the selected at least one data element and stores a copy of the selected at least one data element on the client storage device;
defines a time period for which the copy is considered coherent; and
persists the copy on the client storage device for at least the defined time period.

10. The system of claim 9, wherein the CPU:
sends a request from the client to the server to determine if the copy is still coherent.

11. The system of claim 10 wherein the CPU:
deletes the copy from the client storage device and retrieves the selected at least one data element from the database, and stores a coherent copy of the selected at least one data element on the client storage device when the CPU determines that the copy is no longer coherent.

12. The system of claim 9, wherein the CPU:
selects a plurality of data elements; and
forms a group of selected data elements wherein
the time period for copies of the selected data elements in the group stored on the client storage device is the same.

13. The system of claim 12, wherein the CPU:
sends a single request from the client to the server to determine if at least one of the copies are still coherent.

14. The system of claim 13, wherein the CPU:
deletes the copies from the client storage device and retrieves the group of selected data elements from the database and stores coherent copies of the selected data elements in the group on the client storage device when the CPU determines that at least one of the copies are no longer coherent.

15. The system of claim 9, wherein:
the copy is coherent if an associated property of the stored copy matches an associated property of the selected at least one data element stored on the database.

16. The system of claim 13, wherein:
the copies are considered coherent if an associated property of at least one of the copies of the selected data elements stored on the storage device matches an associated property of at least one of the selected data elements stored on the database.

17. A method of on-disk, client-side caching of data elements, wherein the client is coupled to a server, the method comprising:
selecting at least one data element out of a plurality of data elements stored on a database operatively connected to the server to be cached;
defining a check period for the selected at least one data element;
retrieving the selected at least one data element from the database;
persistently storing a copy of the selected at least one data element in a client's on-disk cache, wherein
the copy is considered to be coherent with the database for at least the check period; and
determining whether the copy is coherent with the database when the check period expires,
wherein if the copy is determined to not be coherent, deleting the copy from the on-disk cache;
re-retrieving the selected at least one data element from the database; and
persistently storing a coherent copy of the selected at least one data element in the on-disk cache.

18. A method of on-disk, client-side caching of data elements, wherein the client is coupled to a server, the method comprising:
selecting data elements to be cached;
defining a group of data elements comprising the selected data elements;
defining a check period for the group of data elements;
retrieving the group of data elements from the database;
persistently storing copies of the data elements in the group in a client's on-disk cache wherein
the copies are considered to be coherent with a database operatively connected to the server for at least the check period; and
determining whether the copies are coherent with the database when the check period expires,
wherein if the copies are determined to not be coherent, deleting the copies from the on-disk cache;
re-retrieving the group of data elements from the database; and
persistently storing coherent copies of the data elements in the group in the on-disk cache.
